(19) United States
(12) Patent Application Publication
(10) Pub. No.: US 2025/0203029 A1
(43) Pub. Date: Jun. 19, 2025

(54) IMAGE FORMING SYSTEM, INFORMATION MANAGEMENT METHOD, AND STORAGE MEDIUM

(71) Applicant: KONICA MINOLTA, INC., Tokyo (JP)

(72) Inventor: Shin OHBA, Toyokawa-shi (JP)

(73) Assignee: KONICA MINOLTA, INC., Tokyo (JP)

(21) Appl. No.: 18/973,237

(22) Filed: Dec. 9, 2024

(30) Foreign Application Priority Data
Dec. 19, 2023 (JP) 2023-213475

(51) Int. Cl. H04N 1/00

(52) U.S. Cl. CPC H04N 1/00912; H04N 2201/0094

(57) ABSTRACT

An image forming system includes a first hardware processor. The processor acquires unit identification information of a unit attached to a first image forming apparatus and unit state information indicating a state of the unit. The first hardware processor registers the acquired unit identification information and the acquired unit state information in a database. The first hardware processor outputs, to a second image forming apparatus, unit state information of a selected unit selected by a user from among units registered in the database.

### CROSS-REFERENCE TO RELATED APPLICATIONS

The entire disclosure of Japanese Patent Application No. 2023-213475 filed on Dec. 19, 2023 is incorporated herein by reference in its entirety.

### TECHNICAL FIELD

The present invention relates to an image forming system, an information management method, and a storage medium.

### DESCRIPTION OF RELATED ART

A typical image forming apparatus includes a main body and a plurality of units attached to the main body. The units are consumable items and replaced at appropriate timing.

In this regard, Japanese Unexamined Patent Publication No. 2011-69951 describes an image forming apparatus that resets the count value of the cumulative total of printed sheets to zero for a new unit when a user removes an old unit that has reached the end of life from the image forming apparatus main body and attaches the new unit.

In recent years, there has been a demand to eliminate wasteful disposal to realize a recycling society. In a reusing operation, a reusable unit having a remaining life is detached from the main body of a disposal-target image forming apparatus, and the unit is attached to a main body of another image forming apparatus as a reusing-target apparatus.

In the reusing operation of image forming apparatuses, information on the used unit (e.g., count value) needs to be transferred to the reusing-target apparatus when the used unit is attached to the reusing-target apparatus. In the known art, an operator needs to display the count value of the used unit to be detached on the disposal-target image forming apparatus (provider apparatus) and to manually input the count value into the reusing-target apparatus (receiver apparatus), which complicates the reusing operation.

An object of the present invention is to provide an image forming system, an information management method, and a storage medium capable of appropriately transferring information of a unit detached from a provider apparatus to a receiver apparatus.

### SUMMARY OF THE INVENTION

To solve the above-described problem, according to an aspect of the present invention, there is provided an image forming system including a first hardware processor configured to acquire unit identification information of a unit attached to a first image forming apparatus and unit state information indicating a state of the unit, register the acquired unit identification information and the acquired unit state information in a database, and output, to a second image forming apparatus, unit state information of a selected unit selected by a user from among units registered in the database.

According to another aspect of the present invention, there is provided an information management method to be executed by a computer of an image forming system, the method including: acquiring unit identification information of a unit attached to a first image forming apparatus and unit state information indicating a state of the unit, registering the acquired unit identification information and the acquired unit state information in a database, and outputting, to a second image forming apparatus, unit state information of a selected unit selected by a user from among units registered in the database.

According to another aspect of the present invention, there is provided a non-transitory computer-readable storage medium storing a program for a computer of an image forming system, the program causing the computer to acquire unit identification information of a unit attached to a first image forming apparatus and unit state information indicating a state of the unit, register the acquired unit identification information and the acquired unit state information in a database, and output, to a second image forming apparatus, unit state information of a selected unit selected by a user from among units registered in the database.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 shows an example of an overall configuration of an image forming system according to the present invention;

FIG. 2 shows a block diagram of a functional configuration of a server;

FIG. 3 shows a schematic configuration diagram of an image forming apparatus;

FIG. 4 shows a block diagram of a functional configuration of the image forming apparatus;

FIG. 5 shows a block diagram of a functional configuration of a first terminal apparatus;

FIG. 6 shows an example of contents of a unit DB;

FIG. 7 is a ladder chart showing the flow of a reusing operation;

FIG. 8 shows an example of a search condition screen to be displayed on a display part of a reusing-target apparatus;

FIG. 9 shows an example of a search result screen to be displayed on the display part of the reusing-target apparatus;

FIG. 10 is a ladder chart showing the flow of the reusing operation in a modification example 1;

FIG. 11 shows an example of a search condition screen to be displayed on a display part of a first terminal apparatus in the modification example 1;

FIG. 12 shows an example of a search result screen to be displayed on the display part of the first terminal apparatus in the modification example 1;

FIG. 13 shows an example of a sheet on which a QR code is printed in a modification example 2;

FIG. 14 shows an example of a QR code screen on which a QR code is shown in the modification example 2:

FIG. 15 shows an example of contents of the unit DB in a modification example 3;

FIG. 16 shows an example of the search condition screen in the modification example 3;

FIG. 17 shows an example of contents of the unit DB in a modification example 4;

FIG. 18 shows an example of contents of the unit DB in a modification example 5; and

FIG. 19 shows an example of the search condition screen in the modification example 5.

### DETAILED DESCRIPTION

Hereinafter, embodiments of the present invention will be described with reference to the drawings. However, the scope of the invention is not limited to the shown examples.

### <1. Configuration of Image Forming System>

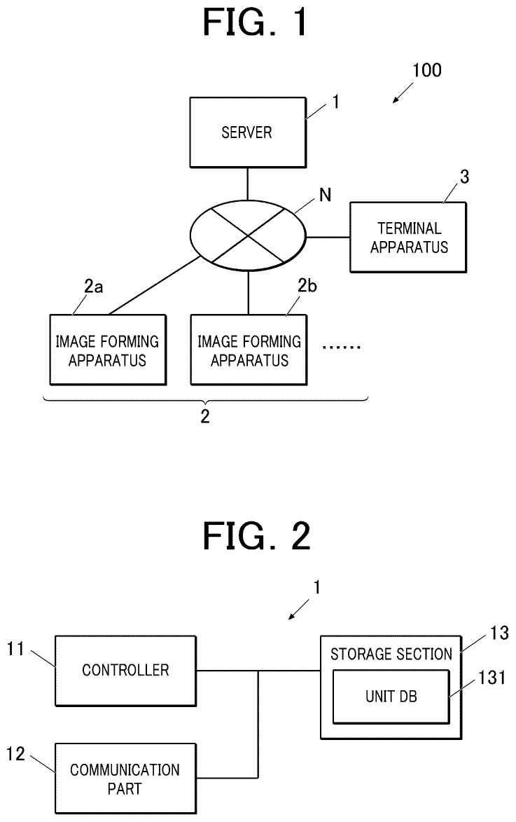

FIG. 1 shows an example of the entire configuration of an image forming system 100 in the present embodiment.

As shown in FIG. 1, the image forming system 100 includes a server 1, an image forming apparatus 2, and a terminal apparatus 3 (first terminal apparatus). The server 1, the image forming apparatus 2, and the terminal apparatus 3 are connected to each other via a communication network N.

The server 1 is a cloud server provided in a cloud environment. The server 1 may be a local server.

The image forming apparatus 2 is a multi-function peripheral (MFP) having a copy function, a scan function, a facsimile function, and the like in addition to an image forming function.

The image forming apparatus 2 includes at least an image forming apparatus 2a as a disposal-target apparatus and an image forming apparatus 2b as a reusing-target apparatus.

The terminal apparatus 3 is a computer device such as a personal computer (PC).

In the reusing operation of the image forming apparatus 2, an operator of a manufacturer takes out a reusable used unit from the image forming apparatus 2a. Herein, the main body of the image forming apparatus 2a is to be disposed (discarded). Next, the operator attaches the used unit, which has been taken out from the image forming apparatus 2a, to the image forming apparatus 2b. The manufacturer sells or rents the image forming apparatus 2b attached with the used unit as a reusing-target apparatus.

### (1-1. Configuration of Server)

FIG. 2 shows a block diagram of a functional configuration of the server 1.

As shown in FIG. 2, the server 1 includes a controller 11 (first hardware processor), a communication part 12, and a storage section 13. These components are connected via a bus.

The controller 11 includes a central processing unit (CPU) and a random-access memory (RAM).

The CPU of the controller 11 reads a system program and various processing programs stored in the storage section 13, loads the programs in the RAM, and executes various processes in accordance with the loaded programs.

The communication part 12 is connected to the communication network N wirelessly or via a wire. The communication part 12 sends and receives data to and from external apparatuses, such as the image forming apparatus 2 and the terminal apparatus 3.

The storage section 13 includes a storage device such as a nonvolatile semiconductor memory and a hard disk.

The storage section 13 stores various programs executed by the controller 11, parameters required to execute processing by the programs, and data such as processing results.

The storage section 13 stores a unit database (DB) 131. The unit DB 131 will be described later.

### (1-2. Configuration of Image Forming Apparatus)

In the present embodiment, the configurations of the image forming apparatuses 2a and 2b are the same and described as the configuration of the image forming apparatus 2.

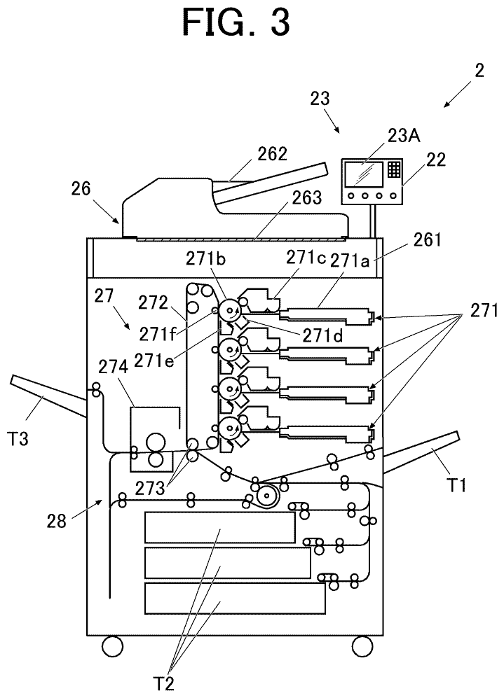

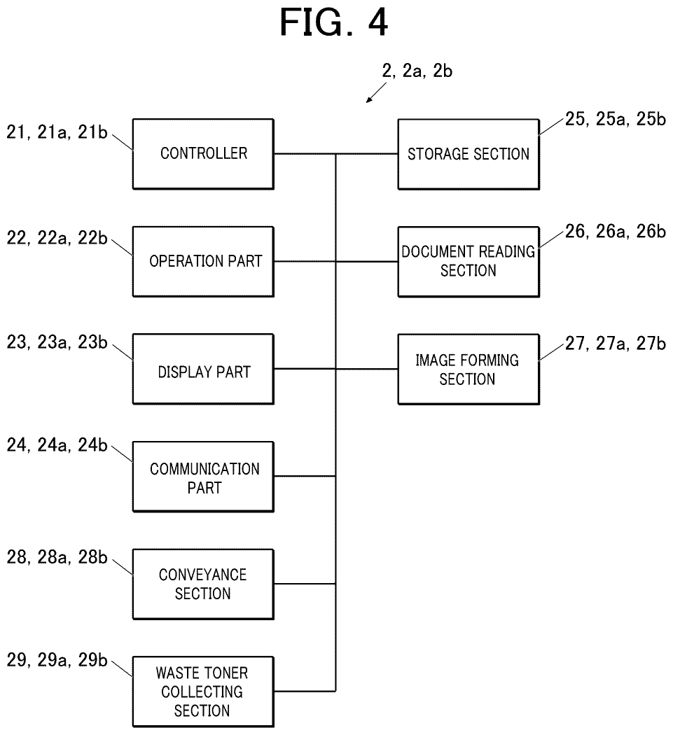

FIG. 3 shows an example of a schematic configuration of the image forming apparatus 2. FIG. 4 is a block diagram of the functional configuration of the image forming apparatus 2.

The image forming apparatus 2 includes a controller 21 (a second hardware processor, a third hardware processor), an operation part 22, a display part 23, a communication part 24, a storage section 25, a document reading section 26, an image forming section 27, a conveyance section 28, and a waste toner collecting section 29.

The controller 21 includes a CPU and a RAM.

The CPU of the controller 21 reads a program stored in the storage section 25, loads the program to the RAM, and controls the components of the image forming apparatus 2 in accordance with the loaded program. For example, the controller 21 performs image processing on image data of a job on the basis of settings of the job input from the outside via the communication part 24. Next, the controller 21 causes the conveyance section 28 to feed the sheet and causes the image forming section 27 to form and fix an image on the sheet.

The operation part 22 includes operation keys and a touch screen integrally formed with the display part 23. The operation part 22 outputs an operation signal corresponding to an input thereon to the controller 21.

The display part 23 includes a liquid crystal display (LCD) panel 23A. The display part 23 displays display information, such as an operation screen, in accordance with instructions by the controller 21.

The communication part 24 includes a network card and is connected to the communication network N. The communication part 24 sends and receives information to and from external apparatuses over the communication network N.

The storage section 25 includes a storage device, such as a nonvolatile semiconductor memory and a hard disk.

The storage section 25 stores programs and files readable by the controller 21.

The storage section 25 stores model information indicating the model of the image forming apparatus 2, a serial number of the main body of the image forming apparatus 2, unit names of units constituting in the image forming apparatus 2, and unit state information of the units, which are described later.

The document reading section 26 includes an automatic document feeder, a scanner 261, a placement tray 262 on which document sheets are placed, and a platen glass 263.

The automatic document feeder includes a mechanism for feeding document sheets and document conveyance rollers. The automatic document feeder feeds the document sheets to a predetermined conveyance path under the control of the controller 21.

The scanner 261 includes a light source, an optical system such as a reflecting mirror, and imaging elements. The scanner 261 reads images on the document sheets conveyed along the predetermined conveyance path or images on the document sheet placed on the platen glass 263.

The image forming section 27 forms images of four colors of C, M, Y, and K on the sheets, based on four-color pixel values of pixels constituting image data subjected to image processing.

As shown in FIG. 3, the image forming section 27 includes four image forming units 271, an intermediate transfer belt 272, secondary transfer rollers 273, and a fixing unit 274.

The four image forming units 271 for the respective four colors of C, M, Y, and K are arranged in series (tandem) along the surface of the intermediate transfer belt 272 to form images in the C, M, Y, and K colors on a sheet. Each of the image forming units 271 includes an exposure section 271a, a photosensitive drum unit 271b, a developing section 271c, a charging section 271d, a cleaning section 271, and a first transfer roller 271f.

The photosensitive drum unit 271b includes a rotatable conductive cylindrical body (photoreceptor). The charging section 271d charges the photoreceptor. The exposure section 271a has a semiconductor laser light source. Under the control of the controller 21, the exposure section 271a drives the semiconductor laser light source based on image data and, with the laser light, irradiates the photoreceptor charged by the charging section 271d to expose the photoreceptor. Under the control of the controller 21, the developing section 271c supplies toner onto the photoreceptor using the charged developing roller and develops an electrostatic latent image formed on the photoreceptor by exposure. The images formed on the respective photoreceptors of the four image forming units 271 are sequentially transferred on one another onto the intermediate transfer belt 272 by the respective first transfer rollers 271f (first transfer). Thus, a color toner image constituted of the four colors is formed on the intermediate transfer belt 272. After the first transfer, the cleaning sections 271 remove the toner remaining on the photoreceptors.

The intermediate transfer belt 272 is an endless belt stretched around rollers and is rotated by the rotations of the rollers under the control of the controller 21.

Under the control of the controller 21, the second transfer rollers 273 transfer the toner image, which is formed on the intermediate transfer belt 272, onto a sheet conveyed from the manual sheet feed tray T1 or the sheet feed tray T2 (second transfer).

The fixing unit 274 includes a heating roller and a pressure roller.

Under the control of the controller 21, the fixing unit 274 applies heat and pressure to the sheet on which the image has been transferred by the second transfer roller 273, thereby fixing the image to the sheet.

The conveyance section 28 includes a sheet feeding roller. In accordance with instructions by the controller 21, the conveyance section 28 conveys a sheet from the manual sheet feed tray T1 or the sheet feed tray T2 to the image forming section 27 by the sheet feeding rollers. The conveyance section 28 ejects the sheet on which the image has been fixed by the fixing unit 274 to a sheet ejection tray T3. The conveyance section 28 has an inversion section that serves as a sheet inversion path. When performing double-sided printing, the sheet with the image fixed on the front side is inverted and returned to the image forming section 27.

The waste toner collecting section 29 includes a waste toner conveyance unit and a waste toner collecting container.

With the waste toner conveyance unit, the waste toner collecting section 29 conveys waste toner removed in the image forming section 27 and accumulates the waste toner in the waste toner collecting container.

### (1-3. Configuration of Terminal Apparatus)

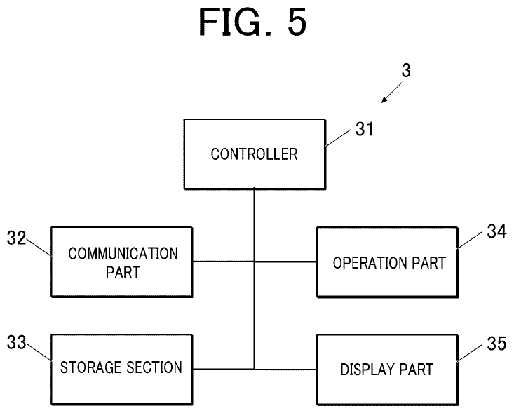

FIG. 5 is a block diagram of the functional configuration of the terminal apparatus 3.

As shown in FIG. 5, the terminal apparatus 3 includes a controller 31 (fourth hardware processor), a communication section 32, a storage section 33, an operation part 34, and a display part 35. These components are connected to each other via a bus.

The controller 31 includes a CPU and a RAM.

The CPU of the controller 31 reads various programs stored in the storage section 33, loads the programs into the RAM, executes various processes in accordance with the loaded programs, and controls operations of the components constituting the terminal apparatus 3.

The communication section 32 sends and receives various signals and data to and from other apparatuses connected over the communication network N.

The storage section 33 includes a storage device such as a nonvolatile semiconductor memory and a hard disk

The storage section 33 stores various programs to be executed by the controller 31, parameters required for executing the programs, and so forth.

The operation part 34 includes a keyboard having cursor keys, number input keys, and various function keys, a pointing device such as a mouse, and a touch screen layered on the surface of the display part 35.

The operation part 34 outputs various signals to the controller 31, based on operations made by an operator.

The display part 35 includes a monitor such as an LCD and displays various screens and contents in accordance with instructions of display signals input by the controller 31.

### <2. Unit DB>

Next, the unit DB 131 stored in the storage section 13 is described.

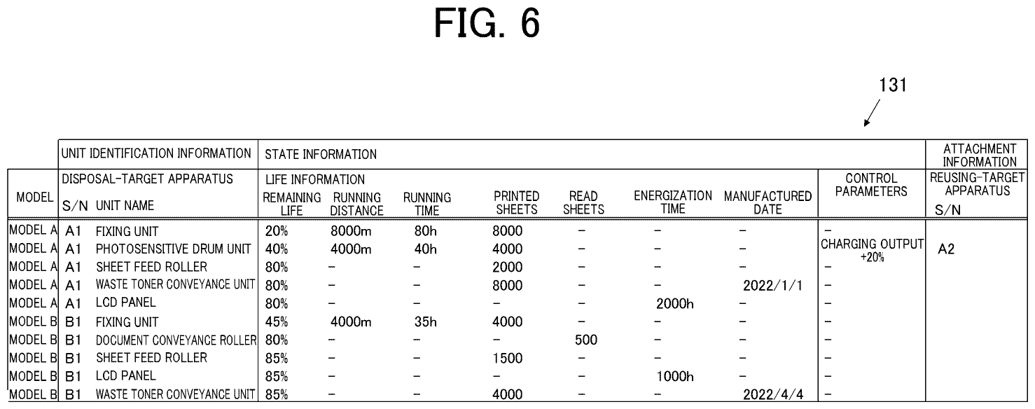

FIG. 6 shows an example of the contents of the unit DB 131.

The unit DB 131 stores unit identification information, unit state information, and attachment information for each of the used units taken out from the image forming apparatus 2a (disposal-target apparatus). Thus, information on units removed from the image forming apparatus 2a (disposal-target apparatus) and stocked can be easily managed in the unit DB 131.

The units in the present embodiment are, for example, the fixing unit 274, the photosensitive drum units 271b, the sheet feed rollers of the conveyance section 28, the waste toner conveyance unit of the waste toner collecting section 29, and the LCD panel 23A.

The unit identification information is for identifying a unit. The unit identification information includes the serial number (S/N) of the main body of the image forming apparatus 2a (disposal-target apparatus) from which the unit has been taken out and the unit name.

The unit state information includes life information and control parameters.

The life information is related to the life of the unit. The life information includes at least one of a remaining life (%), a running distance, a running time, the number of printed (image-formed) sheets, the number of read sheets, an energization time, and a manufactured date.

The controller 21 of the image forming apparatus 2 estimates the remaining life of the unit, based on at least one of the running distance, the running time, the number of printed sheets, the number of read sheets, the energization time, and the manufactured date of the unit. The controller 21 functions as an estimation section. For example, the controller 21 estimates the remaining life by estimating degradation of the unit over time, based on the manufactured date of the unit. For another example, the controller 21 estimates the remaining life by estimating consumption and degradation of the unit, based on the running distance, the running time, the number of printed sheets, the number of read sheets, and the energization time of the unit.

The running distance is a total running distance from the time when the unit is brand-new until the unit is removed from the image forming apparatus 2a (disposal-target apparatus). The running distance is, for example, information corresponding to the fixing unit 274 and the photosensitive drum units 271b.

The running time is a cumulative total running time from the time when the unit is brand-new until the unit is taken out from the image forming apparatus 2a (disposal-target apparatus). The running time is, for example, information corresponding to the fixing unit 274 and the photosensitive drum units 271b.

The number of printed sheets is a cumulative total number of sheets printed from the time when the unit is brand-new until the unit is taken out from the image forming apparatus 2a (disposal-target apparatus). The number of printed sheets is, for example, information corresponding to the fixing unit 274, the photosensitive drum unit 271b, the sheet feed rollers, or the waste toner conveyance unit.

The number of read sheets is a cumulative total number of read documents from the time when the unit is brand-new until the unit is taken out from the image forming apparatus 2a (disposal-target apparatus). The number of read sheets is, for example, information corresponding to the document conveyance roller.

The energization time is a cumulative total time from the time when the unit is brand-new until the unit is taken out from the image forming apparatus 2a (disposal-target apparatus). The energization time is, for example, information corresponding to the LCD panel 23A.

The manufactured date is the date on which the unit was manufactured.

The control parameters are for controlling the unit and have been set to the image forming apparatus 2a (disposal-target apparatus).

The control parameters are, for example, a charging output value of the photosensitive drum units 271b. In the image forming apparatus 2, the film of the photoreceptor becomes thinner as the photoreceptor is abraded by friction with the cleaning blade of the cleaning section 271. The controller 21 sets the charging output value of the photosensitive drum unit 271b, based on the thickness of the photoreceptor. The controller 21 detects the abrasion degree of the film of the photoreceptor, based on the resistance of the current flowing through the photoreceptor. Even when the number of printed sheets is the same, the abrasion degree of the film of the photoreceptor differs between continuous printing and non-continuous printing. In non-continuous printing, the photoreceptor rotates more for printing preparation and post-processing than in continuous printing, and the film of the photoreceptor is more likely to be abraded.

The attachment information is a serial number (S/N) of the image forming apparatus 2b (reusing-target apparatus) to which the unit is attached.

### <3. Reusing Operation of Image Forming Apparatus>

Next, the reusing operation of the image forming apparatus 2 in the image forming system 100 will be described.

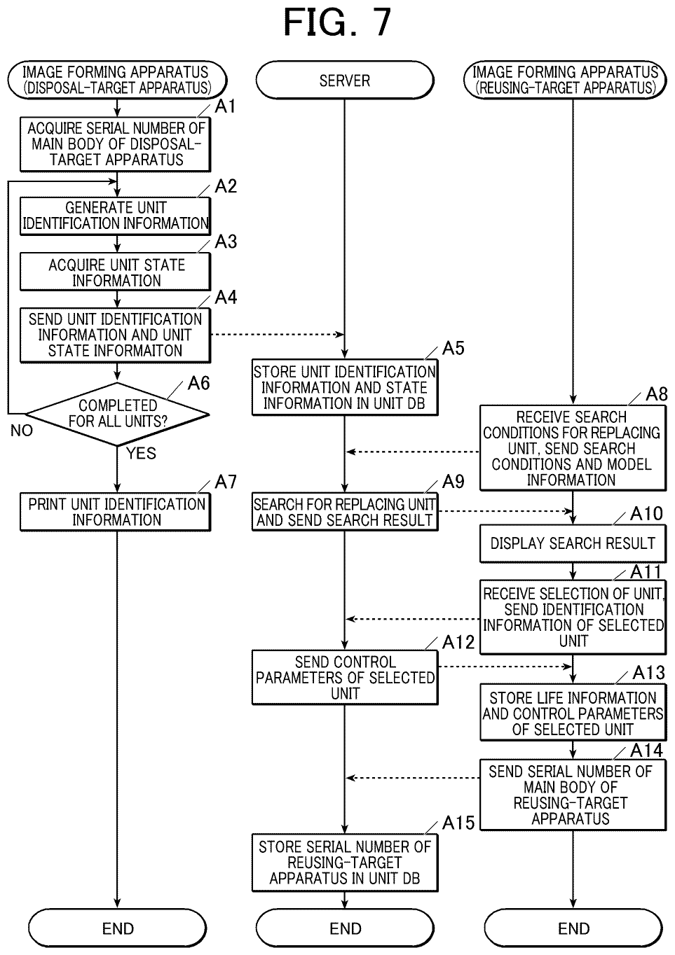

FIG. 7 is a ladder chart showing the flow of the reusing operation of the image forming apparatus 2.

In the reusing operation of the image forming apparatus 2, the controller 21a (second hardware processor) of the image forming apparatus 2a (disposal-target apparatus), the main body of which is to be disposed, receives designation of a unit to be reused via the operation part 22a by the operator.

In response to the designation of the unit, the controller 21a acquires the serial number of the main body of the image forming apparatus 2a from the storage section 25a (step A1).

That is, the controller 21a acquires the serial number for identifying the image forming apparatus 2a (first image forming apparatus). The controller 21a functions as a second acquisition section.

Next, the controller 21a acquires the unit name of the designated unit from the storage section 25a. The controller 21a generates unit identification information including the serial number of the main body of the image forming apparatus 2a acquired in step A1 and the unit name of the designated unit (step A2).

That is, the controller 21a generates the unit identification information by combining the serial number of the image forming apparatus 2a (first image forming apparatus) and the unit name. The controller 21a functions as a first generation section.

Next, the controller 21a acquires unit state information of the designated unit from the storage section 25a (step A3).

Next, the controller 21a sends the unit identification information generated in step A2 and the unit state information acquired in step A3 to the server 1 (step A4).

The controller 11 of the server 1 receives the unit identification information and the unit state information from the image forming apparatus 2a over the communication network N and stores the received information in the unit DB 131 (step A5).

That is, the controller 11 acquires the unit identification information and the unit state information (life information and control parameters) of the unit having been attached to the image forming apparatus 2a (first image forming apparatus). The controller 11 functions as a first acquisition section. The controller 11 registers the unit identification information and the unit state information in the unit DB 131 (database). The controller 11 functions as a registration section. Step A5 is a first acquisition step and a registration step.

After step A4, the controller 21a of the image forming apparatus 2a determines whether the unit identification information and the unit state information of all the designated units have been sent to the server 1 (step A6).

When there is a designated unit for which the unit identification information and the unit state information have not been sent to the server 1 (step A6; NO), the controller 21a proceeds to step A2 and executes the process for the next unit.

When the unit identification information and the unit state information of all the designated units have been sent to the server 1 (step A6; YES), the controller 21a causes the image forming section 27a to print the unit identification information of all the designated units on sheets.

The operator removes the designated units from the main body of the image forming apparatus 2a, attaches the sheet on which the unit identification information is printed to the corresponding unit, and stores the unit as a stock of used units.

At the image forming apparatus 2b, the operator inputs search conditions for a used unit (replacing unit) to be attached to the image forming apparatus 2b (reusing-target apparatus).

The controller 21b (third hardware processor) of the image forming apparatus 2b receives the input of search conditions for a replacing unit via the operation part 22b by the operator.

That is, the controller 21b of the image forming apparatus 2b (second image forming apparatus) receives search conditions for a unit registered in the unit DB 131 (database). The controller 21b functions as a first reception section.

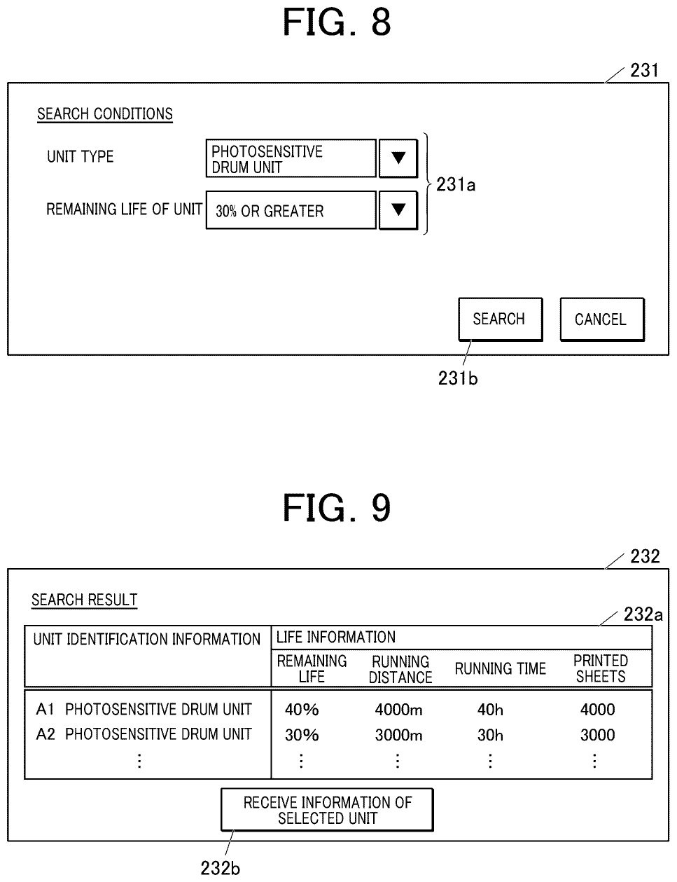

Next, the controller 21b acquires model information of the image forming apparatus 2b from the storage section 25b and sends the acquired model information and the received search conditions to the server 1 (step A8). In step A8, the controller 21b displays a search condition screen 231 as shown in FIG. 8 on the display part 23b and receives inputs of search conditions for a replacing unit.

In the example shown in FIG. 8, the search condition screen 231 includes a search condition input field 23 la and a search button 231b.

The controller 21b receives inputs of search conditions for a replacing unit in the search condition input field 231a. The search conditions for a replacing unit include, for example, the type and remaining life of a unit. When the search button 231b is pressed by the worker, the controller 21b sends the model information of the image forming apparatus 2b and the search conditions for a replacing unit received in the search condition screen 231 to the server 1.

The controller 11 of the server 1 receives the model information of the image forming apparatus 2b and the search conditions for a replacing unit from the image forming apparatus 2b. The controller 11 searches the unit DB 131 for a unit corresponding to the received model information and search conditions.

That is, the controller 11 searches for a unit registered in the unit DB 131 (database), based on the received search conditions. The controller 11 functions as a search section.

Next, the controller 11 sends search result information of a replacing unit to the image forming apparatus 2b (step A9). The search result information of a replacing unit includes unit identification information and life information of a unit extracted by the search.

The controller 21b of the image forming apparatus 2b receives the search result information of the replacing unit from the server 1. Next, the controller 21b displays, on the display part 23b, a search result screen 232 (see FIG. 9) that shows the received search result of the replacing unit (step A10).

That is, the controller 21b displays the search result by the controller 11 on the display part 23b of the image forming apparatus 2b (second image forming apparatus). The controller 21b functions as a second display control section.

In the example shown in FIG. 9, the search result screen 232 includes a search result list 232a and a reception button 232b.

In the search result list 232a, the controller 21b displays a list of unit identification information and life information of the units extracted by the search, as the search result of a replacing unit.

The operator selects a unit to be attached to the image forming apparatus 2b (reusing-target apparatus) from the search result list 232a.

The controller 21b receives the selection of one unit in the search result list 232a by the operator via the operation part 22a. The controller 21b functions as a second reception section.

In response to the reception button 232b being pressed by the operator, the controller 21b sends the unit identification information of the unit selected by the operator to the server 1 (step A11).

The controller 11 of the server 1 receives the unit identification information of the unit selected by the operator from the image forming apparatus 2b. Next, the controller 11 acquires the control parameters corresponding to the received unit identification information from the unit DB 131 and sends the control parameters to the image forming apparatus 2b (step A12). In step A12, the controller 11 may send life information and control parameters corresponding to the received unit identification information to the image forming apparatus 2b.

That is, the controller 11 outputs state information of the unit selected by the user among the units registered in the unit DB 131 (database) to the image forming apparatus 2b (second image forming apparatus). The controller 11 functions as an output section. Step A12 is an output step.

The controller 21b of the image forming apparatus 2b receives the control parameters of the unit selected by the operator from the server 1.

That is, the controller 21b acquires, from the unit DB 131 (database), the state information of the unit whose selection has been received by the second reception section. The controller 21b functions as a fifth acquisition section. Next, the controller 21b stores the life information and the control parameters of the unit selected by the operator in the storage section 25b (step A13).

That is, the controller 21b stores the acquired unit state information. The controller 21b functions as a storage control section.

Next, the controller 21b associates the serial number of the main body of the image forming apparatus 2b with the unit identification information of the unit selected by the operator and sends the associated information to the server 1 (step A14).

The controller 11 of the server 1 receives, from the image forming apparatus 2b, the serial number of the main body of the image forming apparatus 2b associated with the unit identification information of the unit selected by the operator. Next, the controller 11 stores, in the unit DB 131, the received serial number of the main body of the image forming apparatus 2b associated with the unit identification information of the unit selected by the operator as attachment information (step A15).

The controller 11 excludes the unit the attachment information of which is stored in the unit DB 131 from search targets of a replacing unit in the future step A9.

The operator attaches the selected unit to the image forming apparatus 2b, thereby assembling the apparatus 2b as a reusing-target apparatus.

### 4. Modification Examples

Although the present embodiment has been described above, the specific configuration is not limited to the above-described present embodiment and can be changed without departing from the scope of the invention. Hereinafter, modification examples of the present embodiment will be described. In the modification examples, components similar to those of the above embodiment are denoted by the same reference numerals, and description thereof will be omitted.

### Modification Example 1

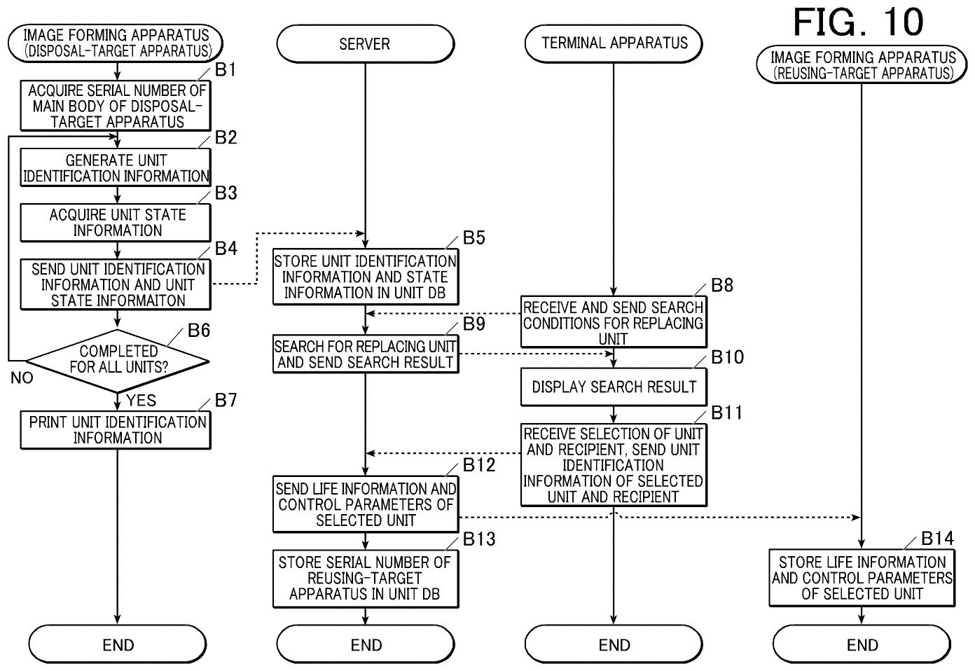

FIG. 10 is a ladder chart illustrating a flow of the reusing operation of the image forming apparatus 2 in a modification example 1.

In the reusing operation of the image forming apparatus 2 in the modification example 1, the image forming apparatus 2a (disposal-target apparatus) and the server 1 execute steps B1 to B7 that are similar to steps A1 to A7 of the above-described embodiment.

In the modification example 1, the operator uses the terminal apparatus 3 to input search conditions for a used unit (replacing unit) to be attached to the image forming apparatus 2b (reusing-target apparatus).

The controller 31 of the terminal apparatus 3 receives the input operation of the searching conditions of the replacing unit by the operator through the operation part 34.

That is, the controller 31 of the terminal apparatus 3 (first terminal apparatus) receives the search conditions for a unit registered in the unit DB 131 (database). The controller 31 functions as a third reception section.

Next, the controller 31 sends the received search conditions to the server 1 (step B8).

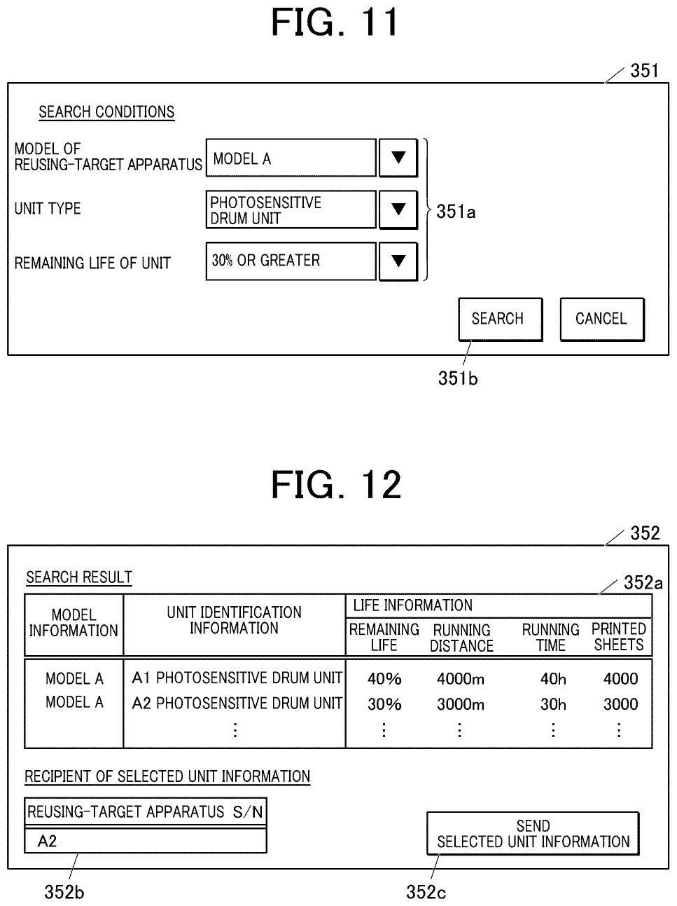

In step B8, the controller 31 displays a search condition screen 351 shown in FIG. 11 on the display part 35 and receives inputs of search conditions for a replacing unit.

In the example shown in FIG. 11, the search condition screen 351 includes a search condition input field 351a and a search button 351b.

The controller 31 receives inputs of search conditions for a replacing unit in the search condition input field 351a. In the first modification example 1, the search conditions of a replacing unit include, for example, model information of the reusing-target apparatus, the unit type, and the remaining life of a unit.

Next, in response to the search button 351b being pressed by the operator, the controller 31 sends the search conditions for a replacing unit received in the search condition screen 351 to the server 1.

The controller 11 of the server 1 receives the search conditions for a replacing unit from the terminal apparatus 3. Next, the controller 11 searches the unit DB 131 for a unit corresponding to the received search conditions for a replacing unit. Next, the controller 11 sends search result information of a replacing unit to the terminal apparatus 3 (step B9). In the modification example 1, the search result information of a replacing unit includes model information, unit identification information, and life information corresponding to the unit extracted by the search.

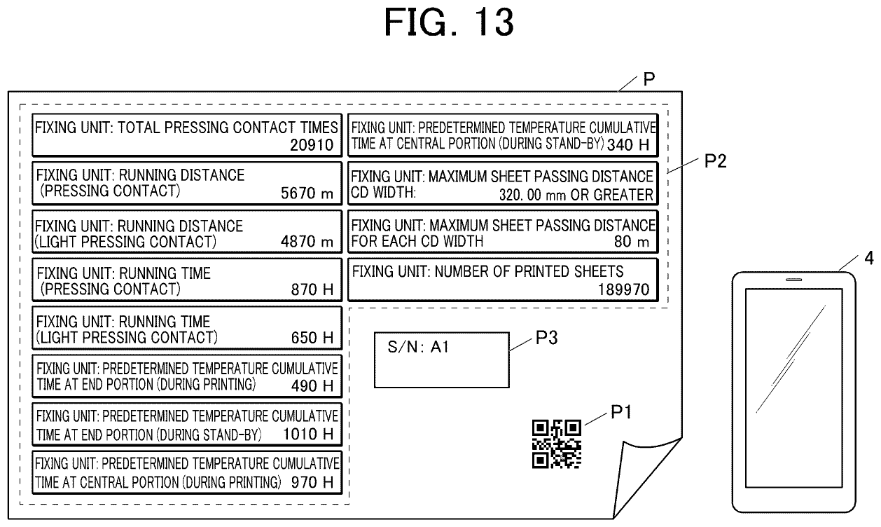

The controller 31 of the terminal apparatus 3 receives the search result information of a replacing unit from the server 1. Next, the controller 31 displays, on the display part 35, the search result screen 352 (see FIG. 12) that shows the received search result of a replacing unit (step B10).

That is, the controller 31 displays the search result by the search section (controller 11) on the display part 35 of the terminal apparatus 3 (first terminal apparatus). The controller 31 functions as a third display control section.

In the example shown in FIG. 12, the search result screen 352 includes a search result list 352a, a recipient input field 352b, and a send button 352c.

In the search result list 352a, the controller 31 displays a list of model information, unit identification information, and life information of units extracted by the search as the search result of a replacing unit.

The operator selects a unit to be attached to the image forming apparatus 2b (reusing-target apparatus) from the search result list 352a.

The controller 31 receives the selection of one unit in the search result list 352a by the operator via the operation part 34. The controller 31 functions as a fourth reception section.

The controller 31 receives, in the recipient input field 352b, an input of the serial number of the main body of the image forming apparatus 2b (reusing-target apparatus) to which the unit is to be attached via the operation part 34 by the operator. The image forming apparatus 2b indicated by the serial number input in the recipient input field 352b is a recipient of the unit state information of the unit selected by the operator.

Next, when the controller 21b receives the pressing operation of the send button 352c by the operator, the controller 2b sends the unit identification information of the unit selected by the operator and the serial number of the main body of the image forming apparatus 2b, which indicates the recipient, to the server 1 (step B11).

The controller 11 of the server 1 receives, from the terminal apparatus 3, the unit identification information of the unit selected by the operator and the serial number of the image forming apparatus 2b main body indicating the recipient. Next, the controller 11 acquires, from the unit DB 131, life information and control parameters corresponding to the received unit identification information. Next, the controller 11 sends the acquired life information and control parameters to the image forming apparatus 2b, which is the recipient indicated by the received serial number (step B12).

Next, the controller 11 associates the received serial number of the main body of the image forming apparatus 2b, which is the recipient, with the unit identification information of the unit selected by the operator, and stores the serial number as attachment information in the unit DB 131 (step B13).

The controller 21b of the image forming apparatus 2b, which is the recipient, receives the life information and the control parameters of the unit selected by the operator from the server 1.

That is, the controller 21b acquires, from the unit DB 131 (database), the unit state information of the unit the selection of which has been received by the fourth selection section (controller 31). The controller 21b functions as a fifth acquisition section.

Next, the controller 21b stores the life information and the control parameters of the unit selected by the operator in the storage section 25b (step B14).

That is, the controller 21b stores the acquired unit state information. The controller 21b functions as a storage control section.

### Modification Example 2

In a modification example 2, the communication part 24a of the image forming apparatus 2a (disposal-target apparatus) is not working, and the image forming apparatus 2a cannot send or receive information to/from external devices.

In the reusing operation of the image forming apparatus 2 in the modification example 2, the operator stores unit identification information and unit state information of the designated unit in the server 1 from the terminal apparatus 3 by using a universal serial bus (USB) memory.

In the reusing operation of the image forming apparatus 2 in the modification example 2, the controller 21a of the image forming apparatus 2a performs the following process instead of step A4. Specifically, the controller 21a generates, for example, a CSV (Comma Separated Values) format file that includes the unit identification information generated in step A2 and the unit state information acquired in step A3. Next, in response to the manipulation of the operation part 22 by the operator, the controller 21a stores the generated file including the unit identification information and the unit state information in the USB memory.

Next, in response to the manipulation of the operation part 34 by the operator, the controller 31 of the terminal apparatus 3 sends the unit identification information and the unit state information in the file stored in the USB memory to the server 1.

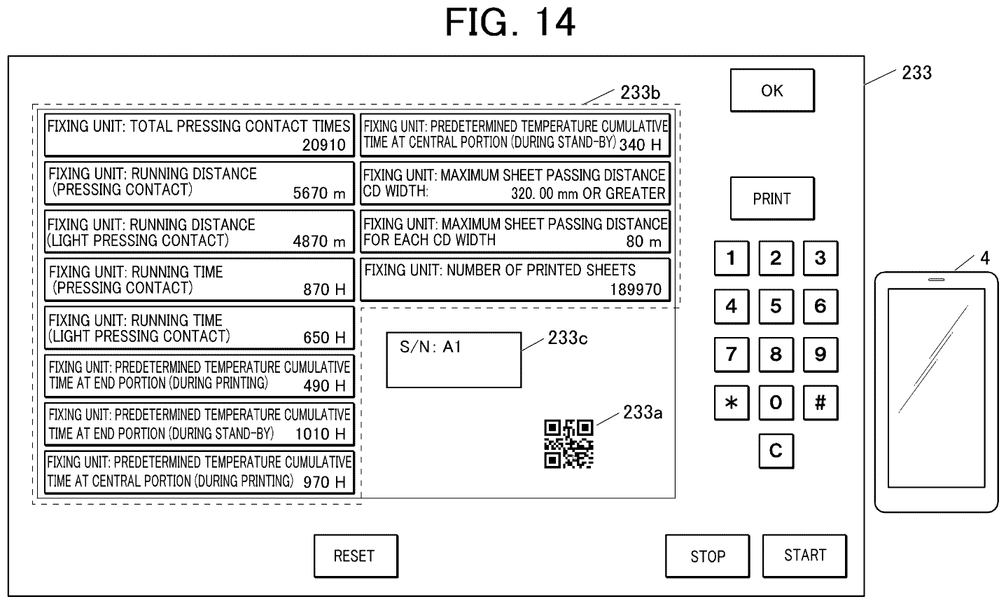

In the reusing operation of the image forming apparatus 2 in the modification example 2, the operator may use a terminal apparatus 4 (second terminal apparatus), such as a smartphone shown in FIGS. 13 and 14, to store the unit identification information and the unit state information of the designated unit in the server 1 by using a quick response (QR) code (registered trademark) that includes the unit identification information and the unit state information. The terminal apparatus 4 is communicably connected to the server 1.

In this case, in the reusing operation of the image forming apparatus 2, the controller 21a of the image forming apparatus 2a executes the following process instead of step A4. Specifically, the controller 21a generates a QR code including the unit identification information generated in step A2 and the unit state information acquired in step A3, and prints the QR code by the image forming section 27a. The controller 21a functions as a second generation section.

FIG. 13 shows an example of a sheet P on which a QR code P1 is printed. As shown in FIG. 13, the controller 21a may print life information P2 of the designated units and serial number P3 of the main body of the image forming apparatus 2a on the sheet P in addition to the QR code P1.

In response to the operator's operation, the terminal apparatus 4 sends, to the server 1, the unit identification information and the state information acquired by reading the QR code P1 printed on the sheet P.

In this case, in the reusing operation of the image forming apparatus 2, the controller 21a of the image forming apparatus 2a may perform the following process instead of step A4. Specifically, the controller 21a generates a QR code including the unit identification information generated in step A2 and the unit state information acquired in step A3, and displays the QR code on the display part 23a. The controller 21a functions as a first display control section.

FIG. 14 shows an example of the QR code screen 233 on which the QR code 233a is displayed. As shown in FIG. 14, the controller 21a may display life information 233b of the designated units and the serial number 233c of the main body of the image forming apparatus 2a in addition to the QR code 233a on the QR code screen 233.

In response to the operation by the operator, the terminal apparatus 4 reads the QR code 233a displayed on the QR code screen 233 and sends the acquired unit identification information and unit state information to the server 1.

### Modification Example 3

In a modification example 3, the storage section 25 of the image forming apparatus 2 stores a jam history and/or a trouble history that occurred in units constituting the image forming apparatus 2. The troubles of units include defective rotation of the fixing roller of the fixing unit, defective pressure-contact/separation of the fixing roller, and malfunction of a sheet elevator of the sheet feed tray, for example.

In step A3 of the reusing operation of the image forming apparatus 2 in the modification example 3, the controller 21a of the image forming apparatus 2a acquires life information and control parameters of the designated unit from the storage section 25a.

The controller 21a then acquires the number of times of jam occurrences in the designated unit from the jam history of the designated unit. Further, the controller 21a acquires the number of times of trouble occurrences in the designated unit from the trouble history of the designated unit. The controller 21a functions as a third acquisition section.

Next, based on the obtained number of times of jam occurrences and the number of times of trouble occurrences, the controller 21a determines the quality of the unit as “excellent”, “good”, “acceptable”, or “unacceptable”, for example. The controller 21a functions as a first determination section.

In step A4 of the reusing operation in the modification example 3, the controller 21a sends the unit identification information generated in step A2 and the unit state information acquired in step A3 to the server 1.

In the modification example 3, the state information includes life information, control parameters, and quality information. The quality information in the modification example 3 includes the number of times of jam occurrences, the number of times of trouble occurrences, and quality determination information indicating the quality determination result.

In step A5 of the reusing operation in the modification example 3, the controller 11 of the server 1 receives the unit identification information and the unit state information from the image forming apparatus 2a and stores the received information in the unit DB 131.

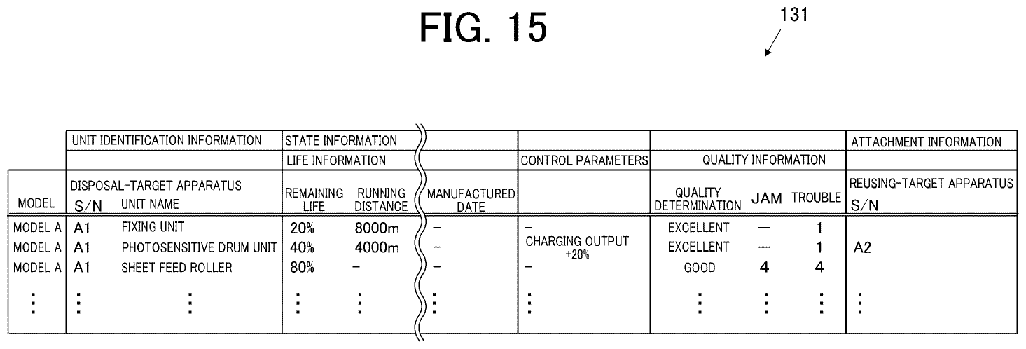

FIG. 15 shows an example of contents of the unit DB 131 in the modification example 3.

The unit DB 131 of the modification example 3 stores unit identification information, unit state information, and attachment information for each of the used units removed from the image forming apparatus 2a (disposal-target apparatus).

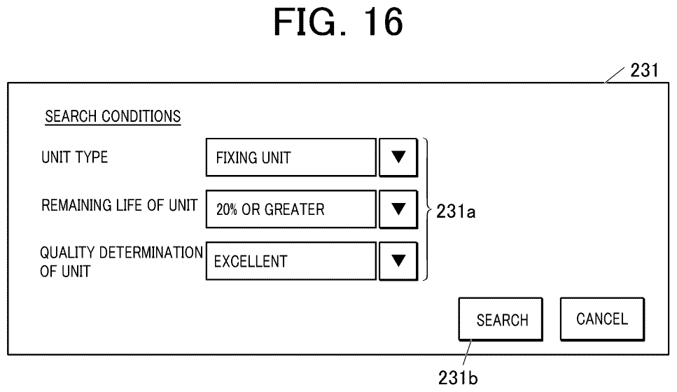

FIG. 16 shows an example of the search condition screen 231 in the modification example 3.

In step A8 of the reusing operation, the controller 21b receives inputs of search conditions for a replacing unit in the search condition input field 231a. As shown in FIG. 16, the search conditions for a replacing unit in the modification example 3 include the unit type, the remaining life, and the quality determination result of a unit.

### Modification Example 4

In the modification example 4, each of the units constituting the image forming apparatus 2 includes a not-illustrated temperature-humidity detector that detects temperature and humidity in the vicinity of the unit. The temperature-humidity detector detects the temperature and humidity in the vicinity of the unit at predetermined time intervals and outputs the detection results to the controller 21.

The controller 21 stores, in the storage section 25, a history of the temperature and humidity in the vicinity of the unit detected by the temperature-humidity detector (temperature and humidity history).

In the modification example 4, the storage section 25 stores a maintenance history of each of the units constituting the image forming apparatus 2. The unit maintenance includes replacement of a broken unit.

In the modification example 4, the storage section 25 stores a history of the toner coverage ratio of images formed by the image forming section 27.

In step A3 of the reusing operation of the image forming apparatus 2 in the modification example 4, the controller 21a of the image forming apparatus 2a acquires life information and control parameters of the designated unit from the storage section 25a.

Next, based on the temperature and humidity history of the designated unit, the controller 21a acquires the total cumulative time (total high-temperature time) during which the temperature is at a high level equal to or greater than a predetermined temperature. Further, based on the temperature and humidity history of the designated unit, the controller 21a acquires the total cumulative time (total high-humidity time) during which the humidity is at a high level equal to or greater than a predetermined humidity. Further, based on the maintenance history of the unit, the controller 21a acquires the number of times the broken unit was replaced in the image forming apparatus 2a. The number of times the broken unit was replaced is the number of times the designated unit was replaced in the image forming apparatus 2a. Further, based on the history of the toner coverage ratio of images formed by the designated unit, the controller 21a acquires the average toner coverage ratio corresponding to the designated unit.

That is, the controller 21a acquires the number of times of unit replacement, information on the temperature and humidity in the vicinity of the unit, and the toner coverage ratio for the unit attached to the image forming apparatus 2a (first image forming apparatus). The controller 21a functions as a fourth acquisition section. The information on the temperature and humidity in the vicinity of the unit is the total high-temperature time and/or the total high-humidity time described above.

Next, the controller 21a determines the quality of the unit as, for example, “excellent”, “good”, “acceptable”, or “unacceptable”, based on the acquired number of times the broken unit was replaced, the total high-temperature time and/or the total high-humidity cumulative time, and the average toner coverage ratio. The controller 21a functions as a second determination section.

In step A4 of the reusing operation in the modification example 4, the controller 21a sends the unit identification information generated in step A2 and the unit state information acquired in step A3 to the server 1. In the modification example 4, the state information includes life information, control parameters, and quality information. In the modification example 4, the quality information includes the number of times the broken unit was replaced, the total high-temperature time and/or the total high-humidity time, the average toner coverage ratio, and quality determination information indicating the quality determination result.

In step A5 of the reusing operation in the modification example 4, the controller 11 of the server 1 receives the unit identification information and the unit state information from the image forming apparatus 2a, and stores the information in the unit DB 131.

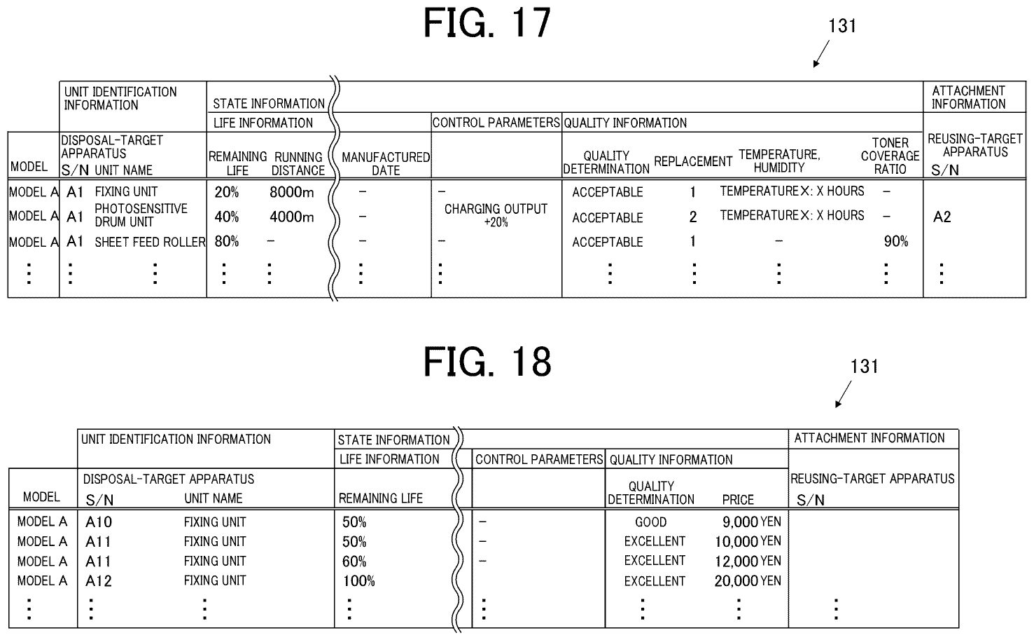

FIG. 17 shows an example of contents of the unit DB 131 in the modification example 4.

In the modification example 4, the unit DB 131 stores the unit identification information, the unit state information, and the attachment information for each of the used units removed from the image forming apparatus 2a (disposal-target apparatus).

The search condition screen 231 in the modification example 4 is the same as the search condition screen 231 in the modification example 3 shown in FIG. 16.

### Modification Example 5

In a modification example 5, the storage section 25 of the image forming apparatus 2 stores information on the price of each of the units constituting the image forming apparatus 2, based on remaining life and quality determination information.

In the modification example 5, in step A3 of the reusing operation of the image forming apparatus 2, the controller 21a of the image forming apparatus 2a acquires life information and control parameters of the designated unit from the storage section 25a.

Next, the controller 21a determines the quality of the designated unit as, for example, “excellent”, “good”, “acceptable”, or “unacceptable”. Specifically, the controller 21a determines the quality of the unit, based on the number of times of jam occurrences and the number of times of trouble occurrences in the unit, for example. Alternatively, the controller 21a determines the quality of the unit, based on the number of times the broken unit was replaced in the image forming apparatus 2a, the total high-temperature time and/or the total high-humidity time of the designated unit, and the average toner coverage ratio corresponding to the designated unit, for example.

Next, the controller 21a calculates the price of the unit, based on the remaining life of the unit, the quality determination result, and the information related to the price of the unit stored in the storage section 25a. The controller 21a functions as a calculation section.

In step A4 of modification the reusing operation in the modification example 5, the controller 21a sends the unit identification information generated in step A2 and the unit state information acquired in step A3 to the server 1.

In the modification example 5, the state information includes life information, control parameters, and quality information. The quality information in the modification example 5 includes a price and quality determination information indicating a quality determination result.

In step A5 of the reusing operation in the modification example 5, the controller 11 of the server 1 receives the unit identification information and the unit state information from the image forming apparatus 2a, and stores the received information in the unit DB 131.

FIG. 18 shows an example of contents of the unit DB 131 in the modification example 5.

In the modification example 5, the unit DB 131 stores the unit identification information, the unit state information, and the attachment information for each of the used units removed from the image forming apparatus 2a (disposal-target apparatus).

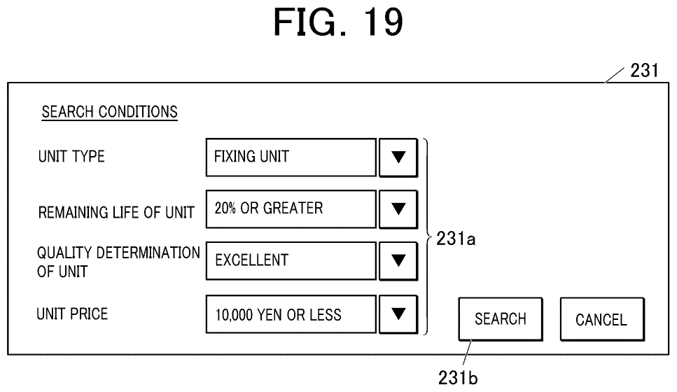

FIG. 19 shows an example of the search condition screen 231 in the modification example 5.

In step A8 of the reusing operation, the controller 21b receives inputs of search conditions for a replacing unit in the search condition input field 231a. As shown in FIG. 19, the search conditions for a replacing unit in the modification example 5 include the unit type, the remaining life, the quality determination result, and the price.

### <5. Effect>

As described above, the image forming system 100 of the present embodiment includes the controller 11 (first acquisition section, first hardware processor) that acquires unit identification information and unit state information of a unit attached to the first image forming apparatus (image forming apparatus 2a).

The image forming system 100 according to the present embodiment includes a registration section (controller 11) that registers, in the database (unit DB 131), the identification information and the unit state information acquired by first acquisition section.

The image forming system 100 according to the present embodiment includes an output section (controller 11) that outputs, to the second image forming apparatus (image forming apparatus 2b), unit state information of a unit selected by the user from among units registered in the database.

According to such a configuration, the operator does not need to cause a provider apparatus to display the count value of the unit to be removed from the provider apparatus and to manually input the count value to a receiver apparatus. Thus, the information related to the unit removed from the first image forming apparatus (provider apparatus) can be suitably transferred to the second image forming apparatus (receiver apparatus).

Furthermore, state information of multiple units removed from the first image forming apparatus (provider apparatus) and stored as a stock can be easily managed in the database.

The image forming system 100 of the present embodiment includes a second acquisition section (controller 21a, second hardware processor) that acquires a serial number for identifying the first image forming apparatus (image forming apparatus 2a).

The image forming system 100 of the present embodiment includes a first generation section (controller 21a) that generates unit identification information of the unit attached to the first image forming apparatus (image forming apparatus 2a) by combining the serial number acquired by the second acquisition section and the unit name.

Thus, the unit identification information can be easily generated.

The image forming system 100 according to the present embodiment includes an estimation section (controller 21a) that estimates the remaining life of the unit attached to the first image forming apparatus (image forming apparatus 2a), based on at least one of the manufactured date, the running distance, the running time, the number of printed sheets, the number of read sheets, and the energization time.

In the image forming system 100 according to the present embodiment, the unit state information includes at least one of the manufactured date, the running distance, the running time, the number of printed sheets, the number of read sheets, the energization time, and the remaining life of the unit.

Thus, the unit state information of the unit removed from the first image forming apparatus (provider apparatus), which includes the manufactured date, the running distance, the running time, the number of printed sheets, the number of read sheets, the energization time, and the remaining life of the unit, can be suitably transferred to the second image forming apparatus (receiver apparatus).

In the image forming system 100 of the present embodiment, the first acquiring section (controller 11) acquires, as the state information, control parameters for controlling the unit attached to the first image forming apparatus (image forming apparatus 2a).

Thus, the control parameters as the unit state information of the unit removed from the first image forming apparatus (provider apparatus) can be suitably transferred to the second image forming apparatus (receiver apparatus).

The image forming system 100 of the present embodiment includes a third acquisition section (controller 21a) that acquires the number of times of jam occurrences and the number of times of trouble occurrences in the unit attached to the first image forming apparatus (image forming apparatus 2a).

The image forming system 100 according to the present embodiment includes a first determination section (controller 21a) that determines the quality of the unit, based on the number of times of jam occurrences and the number of times of trouble occurrences, which are acquired by the third acquisition section.

In the image forming system 100 according to the present embodiment, the unit state information includes a quality determination result of the unit by the first determination section.

Thus, the quality determination result of the unit based on the number of times of jam occurrences and the number of times of trouble occurrences can be easily managed in the database.

The image forming system 100 of the present embodiment includes a fourth acquisition section (controller 2a) that acquires the number of times the unit was replaced in the first image forming apparatus (image forming apparatus 21a), information related to temperature and humidity in the vicinity of the unit attached to the first image forming apparatus, and a toner coverage ratio corresponding to the unit.

The image forming system 100 according to the present embodiment includes a second determination section (controller 21a) that determines the quality of the unit, based on the information on the number of times the unit was replaced, the information related to temperature and humidity, and the toner coverage ratio, which are acquired by the fourth acquisition section.

In the image forming system 100 according to the present embodiment, the unit state information includes a quality determination result of the unit by the second determination section.

Thus, the quality determination result of the unit, which is based on the number of times the unit was replaced, the information related to temperature and humidity in the vicinity of the unit, and the toner coverage ratio, can be easily managed in the database.

The image forming system 100 of the present embodiment includes a calculation section (controller 21a) that calculates the price of the unit, based on the remaining life and the quality determination result of the unit attached to the first image forming apparatus (image forming apparatus 2a).

In the image forming system 100 according to the present embodiment, the state information includes the price of the unit calculated by the calculation section.

Thus, the price of the unit, which is based on the remaining life and the quality determination result of the unit, can be easily managed in the database.

In the image forming system 100 of the present embodiment, the first acquisition section (controller 11) acquires the unit identification information and the unit state information of the unit over the network.

Thus, the unit identification information and the unit state information can be easily acquired.

The image forming system 100 according to the present embodiment includes the first terminal apparatus (terminal apparatus 3) that outputs, to the database, the unit identification information and the unit state information of the unit attached to the first image forming apparatus (image forming apparatus 2a).

Thus, even if the communication part 24a of the first image forming apparatus (image forming apparatus 2a) is not working, the unit identification information and the unit state information of the unit can be easily registered in the database.

The image forming system 100 of the present embodiment includes a second generation section (controller 21a) that generates a QR code (registered trademark) including the unit identification information and the unit state information of the unit attached to the first image forming apparatus (image forming apparatus 2a).

The image forming system 100 of the present embodiment includes the image forming section 27a that forms the QR code generated by the second generation section on a sheet.

The image forming system 100 according to the present embodiment includes the second terminal apparatus (terminal apparatus 4) that reads the QR code on the sheet formed by the image forming section 27a and outputs the unit identification information and the unit state information of the unit included in the read QR code to the database (unit DB 131).

Thus, even if the communication part 24a of the first image forming apparatus (image forming apparatus 2a) is not working, the unit identification information and the unit state information of the unit can be easily registered in the database.

The image forming system 100 of the present embodiment includes a second generation section (controller 21a) that generates a QR code including the unit identification information and the unit state information.

The image forming system 100 according to the present embodiment includes a first display control section (controller 21a) that displays the QR code generated by the second generation section on the display part 23a.

The image forming system 100 of the present embodiment includes the second terminal apparatus (terminal apparatus 4) that reads the QR code displayed on the display part 23a by the first display control section and outputs the unit identification information and the unit state information included in the read QR code to the database (unit DB 131).

Thus, even if the communication part 24a of the first image forming apparatus (image forming apparatus 2a) is not working, the unit identification information and the unit state information of the unit can be easily registered in the database.

The image forming system 100 of the present embodiment includes a second image forming apparatus (image forming apparatus 2b) that includes a first reception section (controller 21b, third hardware processor) that receives a search condition for a unit registered in the database (unit DB 131).

The image forming system 100 of the present embodiment includes a search section (controller 11) that searches for a unit registered in the database based on the search condition received by the first reception section.

The image forming system 100 according to the present embodiment includes a second display control section (controller 21b) that displays a search result by the search section on the display part 23b of the second image forming apparatus.

The image forming system 100 of the present embodiment includes a second reception section (controller 21b) that receives a selection of a unit from the search result by the user.

The image forming system 100 of the present embodiment includes a fifth acquisition section (controller 21b) that acquires, from the database, the unit state information of the unit the selection of which is received by the second reception section.

The image forming system 100 according to the present embodiment includes a storage control section (controller 21b) that stores the unit state information acquired by the fifth acquisition section.

Thus, the user at the second image forming apparatus (image forming apparatus 2b) can search for a unit and cause the second image forming apparatus to suitably receive the unit state information of the selected unit.

The image forming system 100 according to the present embodiment includes the first terminal apparatus (terminal apparatus 3) including a third reception section (controller 31, fourth hardware processor) that receives a search condition for a unit registered in the database (unit DB 131).

The image forming system 100 of the present embodiment includes a search section (controller 11) that searches for a unit registered in the database based on the search condition received by the third reception section.

The image forming system 100 according to the present embodiment further includes a third display control section (controller 31) that causes the display part 35 of the first terminal apparatus to display the search result by the search section.

The image forming system 100 of the present embodiment includes a fourth reception section (controller 31) that receives a selection of a unit from the search result by the user.

The image forming system 100 of the present embodiment includes the fifth acquisition section (controller 21b) that acquires, from the database, the unit state information of the unit the selection of which is received by the fourth reception section.

The image forming system 100 according to the present embodiment includes a storage control section (controller 21b) that stores the unit state information acquired by the fifth acquisition section.

Thus, the user at the first terminal apparatus (terminal apparatus 3) can search for a unit and cause the second image forming apparatus to appropriately receive the unit state information of the selected unit.

The embodiments described above are examples of the image forming system, the information management method, and the storage medium storing a program according to the present invention and not intended to limit the present invention. The detailed configuration and detailed operation of each apparatus constituting the system can be appropriately modified without departing from the scope of the present invention.

For example, although the storage section 13 of the server 1 includes the unit DB 131 in the above embodiment, the present invention is not limited to this. The storage section 33 of the terminal apparatus 3 may include the unit DB 131.

Furthermore, the programs for executing processing in the respective apparatuses may be stored in a portable recording medium. Further, a carrier wave may be applied as a medium for providing program data via a communication line.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming system comprising a first hardware processor configured to
acquire unit identification information of a unit attached to a first image forming apparatus and unit state information indicating a state of the unit,
register the acquired unit identification information and the acquired unit state information in a database, and
output, to a second image forming apparatus, unit state information of a selected unit selected by a user from among units registered in the database.

2. The image forming system according to claim 1, further comprising a second hardware processor configured to
acquire a serial number for identifying the first image forming apparatus and
combine the acquired serial number with a unit name of the unit attached to the first image forming apparatus to generate the unit identification information of the unit attached to the first image forming apparatus.

3. The image forming system according to claim 1, further comprising a second hardware processor configured to estimate a remaining life of the unit attached to the first image forming apparatus, based on at least one of a manufactured date, a running distance, a running time, a number of printed sheets, a number of read sheets, and an energization time of the unit attached to the first image forming apparatus, wherein
the unit state information includes at least one of the manufactured date, the running distance, the running time, the number of printed sheets, the number of read sheets, the energization time, and the remaining life.

4. The image forming system according to claim 1,
wherein the first hardware processor acquires, as the unit state information, a control parameter for controlling the unit attached to the first image forming apparatus.

5. The image forming system according to claim 1, further comprising a second hardware processor configured to
acquire a number of times of jam occurrences and a number of times of trouble occurrences in the unit attached to the first image forming apparatus and
determine a quality of the unit attached to the first image forming apparatus, based on the acquired number of times of jam occurrences and the acquired number of times of trouble occurrences,
wherein the unit state information includes the determined quality of the unit.

6. The image forming system according to claim 1, further comprising a second hardware processor configured to
acquire a number of times the unit attached to the first image forming apparatus was replaced, information related to temperature and humidity around the unit attached to the first image forming apparatus, and a toner coverage ratio corresponding to the unit attached to the first image forming apparatus and
determine a quality of the unit attached to the first image forming apparatus, based on the acquired number of times of replacement, the acquired information related to temperature and humidity, and the acquired toner coverage ratio,
wherein the unit state information includes the determined quality of the unit.

7. The image forming system according to claim 3, wherein:
the second hardware processor calculates a price of the unit attached to the first image forming apparatus, based on the remaining life and a determined quality of the unit attached to the first image forming apparatus, and
the unit state information includes the calculated price of the unit.

8. The image forming system according to claim 1, wherein the first hardware processor acquires the unit identification information and the unit state information over a network.

9. The image forming system according to claim 1, further comprising a first terminal apparatus configured to output the unit identification information and the unit state information of the unit attached to the first image forming apparatus to the database.

10. The image forming system according to claim 1, further comprising:
a second hardware processor configured to generate a QR code (registered trademark) including the unit identification information and the unit state information of the unit attached to the first image forming apparatus;
an image forming section configured to form the generated QR code on a sheet; and
a second terminal apparatus configured to read the QR code formed on the sheet by the image forming section and output the unit identification information and the unit state information included in the read QR code to the database.

11. The image forming system according to claim 1, further comprising:
a second hardware processor configured to generate a QR code including the unit identification information and the unit state information of the unit attached to the first image forming apparatus and display the generated QR code on a display; and
a second terminal apparatus configured to read the QR code displayed on the display and output the unit identification information and the unit state information included in the read QR code to the database.

12. The image forming system according to claim 1, further comprising a third hardware processor included in the second image forming apparatus and configured to receive, at the second image forming apparatus, a search condition for a unit registered in the database, wherein:
based on the search condition received by the third hardware processor, the first hardware processor searches for a unit registered in the database, and
the third hardware processor displays a result of the search on a display of the second image forming apparatus, receives selection of a unit from the result of the search by a user, acquires unit state information of the selected unit from the database, and stores the acquired unit state information of the selected unit.

13. The image forming system according to claim 1, further comprising
a third hardware processor;
a first terminal apparatus; and
a fourth hardware processor included in the first terminal apparatus, wherein:
the fourth hardware processor receives, at the first terminal apparatus, a search condition for a unit registered in the database,
based on the search condition received by the fourth hardware processor, the first hardware processor searches for a unit registered in the database,
the fourth hardware processor displays a result of the search on a display of the first terminal apparatus and receives selection of a unit from the result of the search by a user, and
the third hardware processor acquires, from the database, unit state information of the selected unit and stores the acquired unit state information of the selected unit.

14. An information management method to be executed by a computer of an image forming system, the method comprising:
acquiring unit identification information of a unit attached to a first image forming apparatus and unit state information indicating a state of the unit,
registering the acquired unit identification information and the acquired unit state information in a database, and
outputting, to a second image forming apparatus, unit state information of a selected unit selected by a user from among units registered in the database.

15. A non-transitory computer-readable storage medium storing a program for a computer of an image forming system, the program causing the computer to
acquire unit identification information of a unit attached to a first image forming apparatus and unit state information indicating a state of the unit,
register the acquired unit identification information and the acquired unit state information in a database, and
output, to a second image forming apparatus, unit state information of a selected unit selected by a user from among units registered in the database.
